(19) United States
(12) Patent Application Publication
(10) Pub. No.: US 2025/0368474 A1
(43) Pub. Date: Dec. 4, 2025

(54) Elevator Control Apparatus and Method

(71) Applicants: Hyundai Motor Company, Seoul (KR); Kia Corporation, Seoul (KR); SUNGSHIN WOMEN’S UNIVERSITY R&DB FOUNDATION, Seoul (KR)

(72) Inventors: Jimin Han, Hwaseong-Si (KR); Seong Wook Hwang, Seoul (KR); Jeong Min Oh, Seoul (KR); Hyo Jin Song, Incheon (KR); Yujin Song, Dongducheon-Si (KR); Namgyo Kim, Chuncheon-Si (KR); Joon Young Kim, Seoul (KR); Sihyeon Park, Chungju-Si (KR)

(21) Appl. No.: 18/940,161

(22) Filed: Nov. 7, 2024

(30) Foreign Application Priority Data
May 28, 2024 (KR) 10-2024-0069133

(51) Int. Cl. B66B 1/34; B66B 1/24

(52) U.S. Cl. CPC B66B 1/3476; B66B 1/2408; B66B 2201/215

(57) ABSTRACT

An elevator control apparatus may include a free space detector configured to detect the free space within the elevator based on CCTV within an elevator and data receive by a robot, a boarding demand prediction unit configured to predict a boarding demand of the platform based on platform monitoring data, and an elevator controller configured to determine whether to stop at the platform based on the boarding demand and the free space, where the elevator controller may be configured to predict the number of passengers and the number of robots that can be boarded and provide them to the corresponding platform when it has determined to stop, and to provide a non-stop notification to the corresponding platform when it has determined not to stop.

### CROSS-REFERENCE TO RELATED APPLICATION

This application claims priority to and the benefit of Korean Patent Application No. 10-2024-0069133 filed in the Korean Intellectual Property Office on May 28, 2024, the entire contents of which is incorporated herein by reference.

### BACKGROUND

One or more elevator operation systems may use different stopping operations methods depending on the order of hall calls generated at respective platforms.

In some implementations, some elevator operation systems may predict the boarding size, plan the boarding route, predict the number of passengers, and establish each robot's elevator boarding route, plan, or method, according to the elevator's operation data.

If an individual elevator operation method does not consider information about robot's boarding plan or a robot boarding method, the elevator operation method may not be efficient and may make unnecessary stops.

### SUMMARY

The present disclosure relates to an elevator control apparatus and method utilizing information collected through a robot and a CCTV.

The present disclosure provides an elevator control apparatus and method capable of identifying a space available for boarding on the elevator in real time by using image information identified in real time by an image sensor (e.g., a camera, a closed-circuit television (CCTV)) of an elevator, a robot boarded on the elevator and/or a robot on standby in a hall of respective platforms.

An elevator control apparatus may comprise: a transceiver; an elevator controller; at least one processor; and a memory storing instructions that, when executed by the at least one processor, are configured to cause the elevator control apparatus to: receive, via the transceiver, an image generated using at least one sensor; determine, based on the image and based on data received from a robot, a free space within a first elevator of at least one elevator, wherein the at least one sensor is configured to detect at least one occupant in the at least one elevator, and wherein the at least one occupant comprises at least one of a person or a robot; determine, based on monitoring data associated with a platform, a boarding demand associated with the platform; based on the boarding demand and the free space, determine whether to stop the first elevator at the platform; and control the elevator controller to: stop the first elevator at the platform, and transmit, to a device at the platform using the transceiver, a notification indicating information associated with the free space; or operate the first elevator without stopping at the platform, and transmit, to the device at the platform using the transceiver, a non-stop notification, wherein the device at the platform comprises at least one of the first elevator or a robot located at the platform.

The instructions, when executed by the at least one processor, may be configured to cause the elevator control apparatus to determine the free space in real time when the first elevator stops and an elevator door of the first elevator is opened and after the elevator door of the first elevator is closed.

The instructions, when executed by the at least one processor, may be configured to cause the elevator control apparatus to determine the free space and determine, based on an interior area of the first elevator, a number of passengers in the first elevator and a number of robots that can be accommodated in the free space, wherein the free space is determined based on a number of boarded passengers a number of boarded robots in the first elevator and based on a predetermined occupancy area per passenger and a predetermined occupancy area per robot within the first elevator.

The instructions, when executed by the at least one processor, may be configured to cause the elevator control apparatus to: recognize, via the robot within the first elevator, a passenger or robot being boarded or getting-off when the first elevator stops; detect an expected get-off platform of the passenger or robot based on data associated with the recognized passenger or robot; and predict, based on the detected the expected get-off platform, a free space to be secured at a next stopping platform.

The instructions, when executed by the at least one processor, may be configured to: based on a call button input from the platform, receive, from the robot located at the platform, a number of passengers and robots on standby at the platform as the boarding demand; and predict, based on the boarding demand, a required space within the first elevator.

The instructions, when executed by the at least one processor, may be configured to predict a required space within the first elevator based on: an area of the free space within the first elevator, a number of passengers and robots on standby at the platform, a predetermined occupancy area per passenger within the first elevator, and a predetermined occupancy area per robot within the first elevator.

The instructions, when executed by the at least one processor, may be configured to: based on an elevator call button input from the platform, determine whether to stop the first elevator at the platform.

The instructions, when executed by the at least one processor, may be configured to: based on the free space being smaller than a threshold space, determine not to stop the first elevator at the platform; and based on the free space being larger than the threshold space and based on a determination that the free space and the boarding demand are matched, determine to stop the first elevator at the platform.

The instructions, when executed by the at least one processor, may be configured to: based on a determination that one or more passengers or robots on standby at the platform is able to occupy the free space, determine that the free space and the boarding demand are matched.

The instructions, when executed by the at least one processor, may be configured to: based on a determination to bypass the platform without stopping the first elevator, transmit, to the robot located at the platform, an indication that the first elevator does not stop at the platform, and display, via a display mounted on the robot located at the platform, a message indicating that the first elevator does not stop at the platform.

An elevator control method may comprise: receiving, by an apparatus via a transceiver, an image generated using at least one sensor; determining, based on the image and based on data received from a robot, a free space within a first elevator of at least one elevator, wherein the at least one sensor is configured to detect at least one occupant in the at least one elevator, and wherein the at least one occupant comprises at least one of a person or a robot; determining, based on monitoring data associated with a platform, a boarding demand associated with the platform; based on the boarding demand and the free space, determining whether to stop the first elevator at the platform; and controlling an elevator controller to: stop the first elevator at the platform, and transmit, to a device at the platform using the transceiver, a notification indicating information associated with the free space; or operate the first elevator without stopping at the platform, and transmit, to the device at the platform using the transceiver, a non-stop notification.

The determining the free space within the first elevator may comprise determining the free space in real time when the first elevator stops and an elevator door of the first elevator is opened and after the elevator door of the first elevator is closed.

The determining the free space within the first elevator may comprise determining the free space and determining, based on an interior area of the first elevator, a number of passengers in the first elevator and a number of robots that can be accommodated in the free space, wherein the free space is determined based on a number of boarded passengers a number of boarded robots in the first elevator and based on a predetermined occupancy area per passenger and a predetermined occupancy area per robot within the first elevator.

The determining the free space within the first elevator may comprise: recognizing, via the robot within the first elevator, a passenger or robot being boarded or getting-off when the first elevator stops; detecting an expected get-off platform of the passenger or robot based on data associated with the recognized passenger or robot; and predicting, based on the detected the expected get-off platform, a free space to be secured at a next stopping platform.

The determining the boarding demand associated with the platform may comprise: based on a call button input from the platform, receiving, from the robot located at the platform, a number of passengers and robots on standby at the platform as the boarding demand; and predicting, based on the boarding demand, a required space within the first elevator.

The determining the boarding demand associated with the platform may comprise predicting a required space within the first elevator based on: an area of the free space within the first elevator, a number of passengers and robots on standby at the platform, a predetermined occupancy area per passenger within the first elevator, and a predetermined occupancy area per robot within the first elevator.

The determining whether to stop the first elevator at the platform may comprise based on an elevator call button input from the platform, determining whether to stop the first elevator at the platform.

The determining whether to stop the first elevator at the platform may comprise: based on the free space being smaller than a threshold space, determining not to stop the first elevator at the platform; or based on the free space being larger than the threshold space and based on a determination that the free space and the boarding demand are matched, determining to stop the first elevator at the platform.

The determining whether the free space and the boarding demand are matched may comprise: based on a determination that one or more passengers or robots on standby at the platform is able to occupy the free space, determining that the free space and the boarding demand are matched.

The elevator control method may further comprise: based on a determination to bypass the platform without stopping the first elevator, transmitting, to the robot located at the platform, an indication that the first elevator does not stop at the platform and displaying, via a display mounted on the robot located at the platform, a message indicating that the first elevator does not stop at the platform.

The elevator control method and apparatus may further perform one or more operations described herein.

### BRIEF DESCRIPTION OF THE DRAWINGS

FIG. 1 schematically shows an elevator control system.

FIG. 2 is a signal flowchart of an elevator control system.

FIG. 3 is a block diagram of an elevator control apparatus.

FIG. 4 and FIG. 5 are flowcharts of an elevator control method.

FIG. 6 is a drawing for explaining a free space detection method.

FIG. 7 shows an example computing device.

### DETAILED DESCRIPTION

Examples of the disclosure will be described more fully hereinafter with reference to the accompanying drawings such that a person skill in the art may easily implement one or more features of the present disclosure. As those skilled in the art would realize, the described features may be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

In addition, the terms “unit”, “part” or “portion”, “-er”, and “module” in the specification refer to a unit that processes at least one function or operation, which may be implemented by hardware, software, or a combination of hardware and software.

Hereinafter, examples of the present disclosure will be described with reference to the drawings.

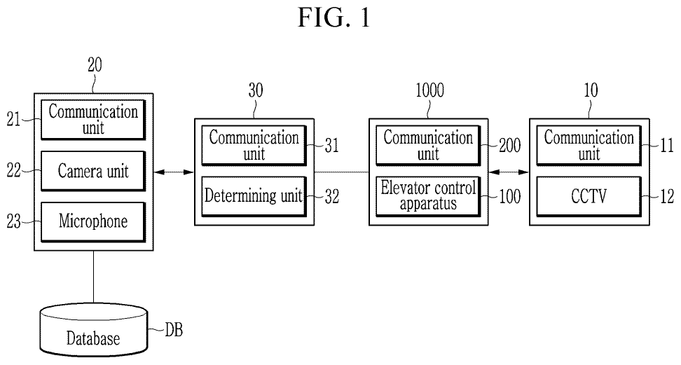

FIG. 1 schematically shows an example elevator control system.

Referring to FIG. 1, the elevator control system may include at least one elevator 10, at least one robot 20, a robot control center 30, and an elevator control center 1000. The robot control center 30 and the elevator control center 1000 may be implemented in a single system including at least one computing device or in a plurality of separate systems.

The elevator 10 may be referred to as an elevator EV. The elevator 10 may refer to a plurality of elevators 10 in one or more structures (e.g., a building). The elevator 10 may refer to each of the plurality of elevators. The building may be a robot-friendly building. For example, the elevator 10 may be one of the plurality of elevators or the plurality of elevators disposed within a building in which robots and people move.

The elevator 10 may include one or more communication devices (e.g., a communication unit 11). The communication unit 11 may control communication between the elevator 10 and the elevator control center 1000. The communication unit 11 may perform and/or control communication with another device (e.g., the elevator control center 1000, the robot 20, and/or the robot control center 30) and/or between the elevator 10 and the robot 20 or the robot control center 30.

One or more communication devices (e.g., the communication unit 11, a communication unit 20, a communication unit 30, and a communication unit 200) may be a transceiver that provides a communication interface with another communication interface provided in other devices (e.g., the elevator 10, the robot 20, the robot control center 30, the elevator control center 1000, etc.), and may receive or transmit various information. The one or more communication devices may include at least one of a mobile communication module, a wireless Internet module, a short-range communication module, an antenna, a receiver, a transmitter, a transceiver (e.g., a wireless transceiver), an wireless communication modem, a wired communication interface, etc.

The mobile communication module may communicate with other communication terminals through a mobile communication network established based on technology standards or communication methods (e.g., GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), LTE (Long Term Evolution), LTE-A (Long Term Evolution-Advanced), 5G NR (New Radio), and/or the like) for mobile communication.

The wireless Internet module may be a module for wireless Internet access, and may communicate with the telematics terminals through WLAN (Wireless LAN), Wi-Fi, Wi-Fi Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), an LTE (Long Term Evolution), LTE-A (Long Term Evolution-Advanced), 5G NR (New Radio), and/or the like. For example, the wireless Internet module may include a network interface card (NIC), a modem, a router, a switch, a gateway, an access point (AP), and/or an antenna.

The short-range communication module may support short-range communication with the telematics terminals using at least one of Bluetooth™ RFID (Radio Frequency Identification), IrDA (Infrared Data Association), UWB (Ultra Wideband), ZigBee, NFC (Near Field Communication), and/or Wireless USB (Wireless Universal Serial Bus).

An image sensor (e.g., a camera, a CCTV 12) may be disposed inside the elevator 10. The CCTV 12 may photograph the inside of the elevator 10. Each elevator 10 may include a plurality of image sensors (e.g., a plurality of cameras or a plurality of CCTVs 12).

The CCTV 12 may photograph a passenger or a robot within the elevator 10 and provide the image to the elevator control center 1000, the robot 20, and/or the robot control center 30.

The robot 20 may be a moving robot. The robot 20 is not particularly limited, and may include various types and forms of robots moving in the robot-friendly building.

The robot 20 may move into the elevator 10 or may move outside the elevator 10. The robot 20 may collect and provide data or information required for controlling the elevator 10 from inside or outside elevator 10.

The robot 20 may include the communication unit 21, a camera unit 22 (e.g., at least one camera), and a microphone 23.

The communication unit 21 may be responsible for communication between the robot 20 and the robot control center 30. The communication unit 21 may provide data or information collected by the robot 20 to the robot control center 30. The robot 20 may be assigned with tasks from the robot control center 30 through the communication unit 21.

The camera unit 22 may serve as an eye of the robot 20. The camera unit 22 may include a camera mounted on the robot 20. The camera unit 22 may photograph periphery of the camera, and collect data on the people, objects, robots, or space of the periphery.

The microphone 23 may serve as a mouth of the robot. The robot 20 may audibly provide a notification or information to the periphery through the microphone 23.

The robot 20 may further include a display unit (e.g., at least one display). The robot 20 may visually provide notification or information to the periphery through the display unit.

The robot 20 is connected to a database DB such that data and information collected by the robot 20 may be stored in the database DB, and necessary information may be fetched from the database DB and used.

For example, the robot 20 may recognize the passenger being boarded on the elevator 10, and may obtain information on the recognized passenger from the database DB. For example, the database DB may provide, to the robot 20, various information such as occupation, workspace, office location, contact information, and the elevator use history of the recognized passenger.

The robot control center 30 may perform integrated control on a plurality of robots 20 within the building.

The robot control center 30 may include a communication unit 31 and a determining unit 32 (e.g., one or more processors and memory storing instructions that, when executed by the one or more processors, cause the robot control center 30 to perform one or more operations of the robot control center 30 described herein).

The communication unit 31 may be responsible for communication between the robot control center 30, the robot 20, and the elevator control center 1000.

The determining unit 32 may integrate information collected by the robots 20 within the building, collect them depending on areas within the building (inside elevator or outside elevator), and transfer them to the elevator 10 or the elevator control center 1000.

The elevator control center 1000 may integrally control the elevator 10 in the building.

The elevator control center 1000 may include the elevator control apparatus 100 and a communication unit 200.

The elevator control apparatus 100 (e.g., one or more processors and memory storing instructions that, when executed by the one or more processors, cause the elevator control center 1000 to perform one or more operations of the elevator control center 1000 described herein) may comprehensively collect the elevator internal call received from the elevator 10 and a platform call of each floor or each platform.

The elevator control apparatus 100 may integrate the boarding demand information of the platform of each floor obtained through the robot control center 30, and based on this, may control the elevator 10.

For example, the elevator control apparatus 100 may distribute boarding demand information on a plurality of platforms to the plurality of elevators 10, and the elevator 10 matching the boarding demand information may be appropriately assigned to respective planform.

The communication unit 200 may be responsible for communication between the elevator control center 1000 and the elevator 10 or the robot control center 30. The elevator control center 1000 may exchange data and information with the elevator 10 and the robot control center 30 through the communication unit 200.

Although it is illustrated in FIG. 1 that the elevator control apparatus 100 is included inside elevator control center 1000, it is not necessarily limited thereto, and the elevator control apparatus 100 may be installed outside elevator control center 1000 and may exchange information through communication with the elevator control center 1000.

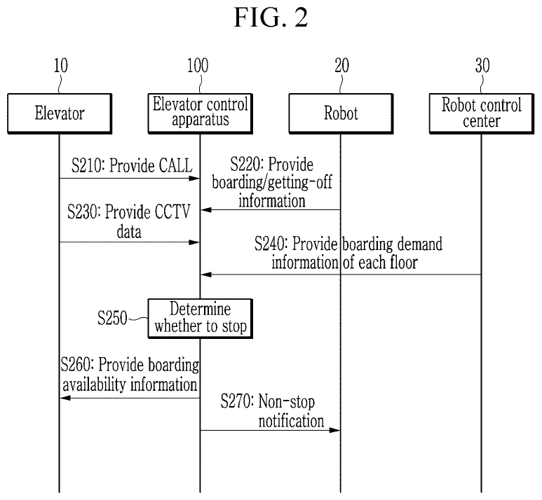

FIG. 2 is a flowchart of the example elevator control system.

In FIG. 2, at step S210, the elevator control apparatus 100 may be provided with information on the elevator call from the elevator 10.

The elevator 10 may provide the elevator internal call information input by the passenger or robot within the elevator and the elevator external call information input by the passenger or robot outside the elevator 10 to the elevator control apparatus 100.

At step S220, the robot 20 may provide information on boarding or getting-off on the elevator of the passenger or robot to the elevator control apparatus 100. For example, the robot 20 boarded inside elevator may detect the passenger or robot being boarded on or getting off from the elevator, and notify it to the elevator control apparatus 100.

The robot 20 may detect the passenger or robot being boarded on or getting off from the elevator at every platform, and may provide it to the elevator control apparatus 100 through the robot control center 30.

At step S230, the elevator control apparatus 100 may be provided with CCTV data for inside elevator from the elevator 10. The elevator 10 may count the passenger or robot inside elevator through an internal camera or CCTV.

The CCTV data may include information on CCTV photographing image, the number of passengers and the number of robots inside of the elevator.

At step S240, the robot control center 30 may provide the boarding demand information including the number of passengers or robots to be boarded at every platform of each floor to the elevator control apparatus 100.

The robot 20 of each floor platform may count the number of passengers and robots existing at the corresponding platform, and transfer it to the robot control center 30. The robot control center 30 may receive the boarding demand information from the robot 20 existing on each floor platform and provide them to the elevator control apparatus 100.

At step S250, the elevator control apparatus 100 may determine whether the elevator 10 stops at respective floor.

The elevator control apparatus 100 may determine whether to stop at the platform based on the CCTV data received from the elevator 10 and the boarding demand information of each floor platform received from the robot control center 30.

The elevator control apparatus 100 may detect a free space within the elevator 10 based on the CCTV data received from the elevator 10.

The elevator control apparatus 100 may determine whether to stop at a respective platform based on the free space within the elevator and the boarding demand of the platform.

When a boarding demand of a specific platform matches the free space within the elevator, the elevator control apparatus 100 may stop the elevator at the corresponding platform. At this time, the elevator control apparatus 100 may detect boarding availability information, which includes the number of passengers and/or the number of robots that can be boarded on the elevator having stopped at the platform.

At step S260, if it is determined to stop at the platform, the elevator control apparatus 100 may provide the boarding availability information to the elevator 10.

The elevator 10 determined to stop may provide the boarding availability information to the platform through the elevator control center 1000.

At step S270, if it is determined not to stop at the platform, the elevator control apparatus 100 may provide a non-stop notification to the robot 20.

The elevator control apparatus 100 may transmit the non-stop notification to the robot 20 on standby at the non-stopping platform. The robot 20 on standby may visually and/or audibly notify non-stopping of the elevator to nearby robots and/or individuals.

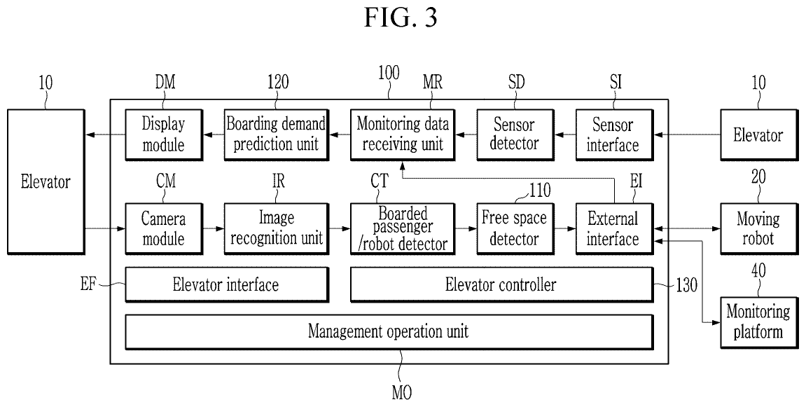

FIG. 3 is a block diagram of the elevator control apparatus.

The elevator control apparatus 100 may determine whether to stop at the plurality of platforms with respect to the plurality of elevators. The elevator control apparatus 100 may determine whether to stop the elevator at the platform, for example, based on the free space within the elevator and the boarding demand on standby at the platform.

During this process, the elevator control apparatus 100 may interact with the elevator, the CCTV, and/or the robot.

Referring to FIG. 3, the elevator control apparatus 100 may include a free space detector 110 (e.g., one or more processors and memory storing instructions that, when executed by the one or more processors, cause the elevator control apparatus 100 to perform one or more operations of the elevator control apparatus 100 described herein to detect a free space in the elevator 10), a boarding demand prediction unit 120 (e.g., one or more processors and memory storing instructions that, when executed by the one or more processors, cause the elevator control apparatus 100 to perform one or more operations of the elevator control apparatus 100 described herein to predict a boarding demand associated with each elevator 10) and an elevator controller 130.

The free space detector 110 may detect the free space within the elevator based on a CCTV within elevator and the data received from a robot.

If the elevator stops and the elevator door is opened and closed, the free space detector 110 may detect the free space in real time.

The free space detector 110 may calculate the free space and the number of passengers or robots that can be additionally boarded on the free space based on an interior area of the elevator, the number of boarded passengers or robots, and a predetermined occupancy area per passenger and a predetermined occupancy area per robot within the elevator.

if the elevator stops, the free space detector 110 may recognize passengers or robots being boarded or getting-off (e.g., via communication with the robot within the elevator).

The free space detector 110 may detect an expected get-off platform of the passenger or robot based on data with respect to the recognized passenger or robot.

The free space detector 110 may predict a free space within the elevator to be secured at the next stopping platform based on the detected the expected get-off platform.

The boarding demand prediction unit 120 may predict the boarding demand of the platform based on platform monitoring data.

If a call button is input from the platform, the boarding demand prediction unit 120 may receive the number of passengers and robots on standby at the platform (e.g., provided from the robot existing at the platform or provided by an image sensor of the platform detecting the number of passengers and robots on standby at the platform) as the boarding demand, and may predict a required space within the elevator based on the received boarding demand.

The boarding demand prediction unit 120 may predict the required space within the elevator based on the area of the free space within the elevator, the number of passengers and robots on standby at the platform, and the predetermined occupancy area per passenger or the predetermined occupancy area per robot within the elevator.

The elevator controller 130 may determine whether to stop at the platform based on the boarding demand and the free space.

If it is determined to stop, the elevator controller 130 may predict the number of passengers and the number of robots that can be boarded and provide them to corresponding platform. If it is determined not to stop, the elevator controller 130 may provide the non-stop notification to the corresponding platform.

If an elevator call button is input from the platform, the elevator controller 130 may determine whether to stop at the corresponding platform of the elevator. If there is not enough free space within the elevator, the elevator controller 130 may determine not to stop at the platform.

If there is enough free space within the elevator, the elevator controller 130 may determine whether the free space and the boarding demand of the platform are matched, and may determine to stop the corresponding elevator at the corresponding platform, for example, if the free space and the boarding demand of the platform are matched.

If at least one passenger or robot on standby at the platform may occupy the free space, the elevator controller 130 may determine that the free space and the boarding demand are matched.

If it is determined not to stop at the platform, the elevator controller 130 may notify it to the robot on standby on the corresponding platform.

The notified robot on standby may notify it to passengers on standby through a display included in the robot.

The elevator control apparatus 100 may include one or more sensors (e.g., image sensors, such as a camera module CM, and an image recognition unit IR, and/or a boarded passenger/robot detector CT).

The camera module CM may control a CCTV camera within the elevator, the image recognition unit IR may recognize the passenger and robot within the elevator through images and fixed pictures, and the boarded passenger/robot detector CT may count the number of the recognized passengers and robots, respectively.

The boarded passenger/robot detector CT may identify the type of the robots according to the size and height, and may perform counting depending on the type.

The free space detector 110 may identify the space within the elevator density based on the counting result of the passengers and robots, and detect the free space.

The free space detector 110 may detect whether there is enough free space within the elevator based on the elevator space density data, and level the free space by size.

The elevator control apparatus 100 may include an external interface EI. The elevator control apparatus 100 may transfer the detected free space within the elevator information to a moving robot 20 inside and outside elevator through the external interface EI.

The elevator control apparatus 100 may include a sensor interface SI. The elevator control apparatus 100 may include a sensor detector SD. The elevator control apparatus 100 may control an operation of the sensor of the elevator 10, and may detect data detected by the sensor of the elevator 10 through the sensor detector SD. The sensor may include, for example, a load sensor, a weight sensor, an environment sensor, a door sensor, an emergency stop sensor, or the like.

The elevator control apparatus 100 may include a monitoring data receiving unit MR.

For example, the monitoring data receiving unit MR may receive monitoring information on air condition and ventilation condition of the elevator and platform situation for respective floors.

The monitoring data receiving unit MR may receive environment condition information or the like within the elevator 10 through the sensor detector SD.

The monitoring data receiving unit MR may receive monitoring information on platform from the moving robot 20 and a monitoring platform 40 through the external interface EI. The monitoring information may include the boarding demand on standby at the platform.

The boarding demand prediction unit 120 may predict the boarding demand based on data received through the monitoring data receiving unit MR.

The elevator control apparatus 100 may include a display module DM. The display module DM may display various information of the elevator 10. For example, the display module DM may display various monitoring information.

The elevator control apparatus 100 may directly display the situation of the robot or the like within the elevator through the display module DM.

The elevator control apparatus 100 may include an elevator interface EF. The elevator control apparatus 100 may include the elevator controller 13. The elevator control apparatus 100 may include a management operation unit MO.

The elevator control apparatus 100 may manage interfaces within the elevator through the elevator interface EF. The elevator controller 130 may control the call button of the elevator 10, control a movement of the elevator 10, and control whether the elevator 10 stops.

The management operation unit MO (e.g., one or more processors and memory storing instructions that, when executed by the one or more processors, cause the elevator control apparatus 100 to perform one or more operations of the elevator control apparatus 100 described herein to manage the elevator interface and the elevator controller 130) may integrally manage the elevator interface EF and the elevator controller 130.

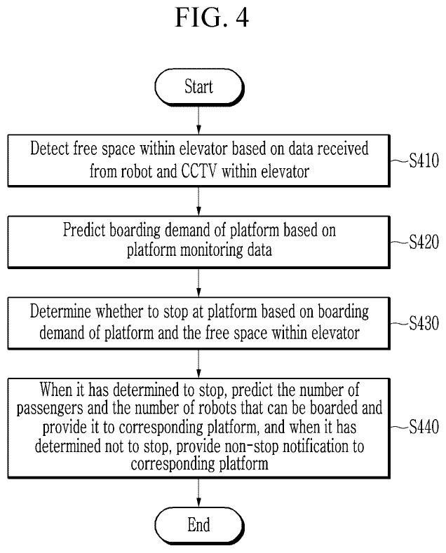

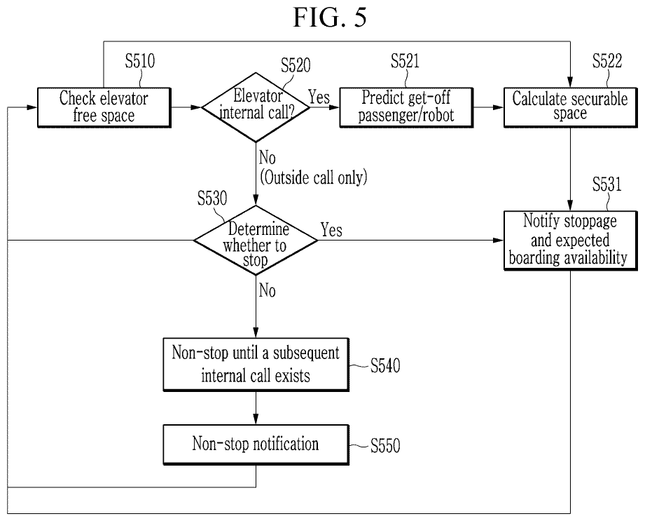

FIG. 4 and FIG. 5 are flowcharts of the elevator control method. The elevator control method of FIG. 4 and FIG. 5 may be performed by the elevator control apparatus 100 (see FIG. 1) and/or any other devices/apparatuses.

In FIG. 4, at step S410, the elevator control apparatus 100 may detect the free space within the elevator based on CCTV within elevator and the data received from one or more robots.

If the elevator door is opened and closed, the elevator control apparatus 100 may check the free space within the elevator through the CCTV.

The robot within the elevator (e.g., continuously or periodically) receive commands to perform tasks from the robot control center, and may determine floors to stop and report it to the elevator control center.

At step S420, the elevator control apparatus 100 may predict the boarding demand of the platform based on platform monitoring data.

At step S430, the elevator control apparatus 100 may determine whether to stop at the platform based on the boarding demand of the platform and the free space within the elevator.

The elevator control apparatus 100 may determine whether to stop differently according to the type of the elevator call.

The elevator control apparatus 100 may determine to (e.g., always) stop in the case of the elevator internal call.

If it always stops by the elevator internal call, the elevator control apparatus 100 may predict the number of robots and/or passengers expected to get off at the stop,

The elevator control apparatus 100 may predict the free space within the elevator on a subsequent arrival floor based on the predicted number of robots and/or passengers expected to get off.

If the call button is input from the platform, the elevator control apparatus 100 may receive the number of passengers and robots on standby at the platform provided from the robot existing at the platform as the boarding demand and predict the required space within the elevator based on the receive boarding demand.

In the case of the elevator external call or the platform call, the elevator control apparatus 100 may predict the boarding demand based on the number of robots existing on the corresponding platform and the number of passengers on standby in front of the elevator, and expect the free space required for the elevator, to determine whether to stop by comparing it with a current free space.

At step S440, if it is determined to stop the elevator 10, the elevator control apparatus 100 may predict the number of passengers and the number of robots that can be boarded and provide them to corresponding platform. If it is determined not to stop the elevator 10, the elevator control apparatus 100 may provide the non-stop notification to the corresponding platform.

That is, if it determines to stop, the elevator control apparatus 100 may notify the number of passengers and/or the number of robots that can be boarded on the elevator at the corresponding platform to the platform in advance through a display of the platform or the robot on standby at the platform.

If it determines to pass the corresponding platform (non-stop), the elevator control apparatus 100 may notify it to the robot on standby on the corresponding floor in advance. The robot on standby may notify the corresponding information to the platform through a display and voice user interface (VUI).

If the platform has been passed without stopping, until a subsequent elevator internal call occurs, the elevator control apparatus 100 may continue not to stop on all floors, due to lack of the boarding space.

If the elevator 10 stops once after moving between floors or platforms, the elevator control apparatus 100 may repeat the step S410 of checking the free space within the elevator. Here, the stop event of the elevator 10 may include an door operation of the elevator, such as an operation that the elevator door is opened and closed once, and there is a change in the number of passengers and/or the number of robots occupying the space within the elevator.

The elevator control apparatus 100 may repeat the step S410 to step S400, to reduce unnecessary stopping and to operate the elevator appropriately for the situation.

FIG. 5 is a flowchart showing a specific example of the elevator control method. In FIG. 5, at step S510, the elevator control apparatus 100 may check the elevator free space in real time. If the elevator door is opened and closed, the elevator control apparatus 100 may check the free space within the elevator through the CCTV or the robot within the elevator.

At step S520, if the elevator call is received, the elevator control apparatus 100 may check whether the elevator internal call is included.

If a plurality of elevator calls are received, the elevator control apparatus 100 may check whether at least one elevator internal call is included in them.

At step S521, if the elevator internal call is confirmed, the elevator control apparatus 100 may predict the number of passengers and the number of robots getting off at the platform according to the confirmed internal call.

The elevator control apparatus 100 may confirm whether the confirmed internal call is a human call input by a human or a robot call input by a robot. The elevator control apparatus 100 may classify the human call and the robot call to count them.

If the elevator stops, the elevator control apparatus 100 may recognize the passenger and/or robot boarded or getting off at the stop (e.g., via a communication with the robot within the elevator).

In the case of robot, the elevator control apparatus 100 may predict a get-off floor of the robot based on data with respect to the robot received through the robot control center.

In the case of passengers, the elevator control apparatus 100 may receive prediction information on the platform expected to get off for each boarded passenger detected from the robot within the elevator.

For example, the robot within the elevator may check faces of passengers boarded on the elevator by the camera, predict the get-off floor of the corresponding passenger based on data on the face confirmed from the database, and provide them to the elevator control apparatus 100.

The robot may provide data to the robot control center, and the elevator control apparatus 100 may receive data from the robot control center.

The elevator control apparatus 100 may predict a get-off floor of the passenger within the elevator based on data or information on the passenger or robot received from the robot.

At step S522, the elevator control apparatus 100 may predict the free space that can be additionally secured until the next stopping platform is reached by using the predicted get-off floor. Here, subsequent platform may be a stopping platform according to the elevator external call.

At step S530, if the elevator internal call has not been confirmed but only the external call has been confirmed, the elevator control apparatus 100 may determine whether to stop according to the corresponding call.

If the elevator call button is pressed by an individual from the platform, the elevator control apparatus 100 may determine whether to stop at the platform of the elevator. In particular, the elevator control apparatus 100 may (e.g., always) determine to stop in the case of internal call. On the other hand, in the case of the elevator external call or the platform call, the elevator control apparatus 100 may determine whether to stop depending on whether there is the free space within the elevator.

At step S540, if there is not enough free space within the elevator, the elevator control apparatus 100 may determine not to stop at the platform even if the external call is confirmed.

The elevator control apparatus 100 does not stop the elevator until a subsequent internal call occurs.

If there is enough free space, the elevator control apparatus 100 may determine to stop at the platform according to the external call.

The elevator control apparatus 100 may determine whether the free space and the boarding demand are matched, and may determine to stop at the platform (e.g., when they are matched).

If at least one passenger or robot on standby at the platform can occupy the free space, the elevator control apparatus 100 may determine that the free space and the boarding demand are matched.

That is, if there exists the boarding demand of robot at the platform, even if the free space for passengers exists within the elevator, the elevator control apparatus 100 may determine that the boarding demand and the free space are not matched to each other, and the elevator may not stop at the corresponding platform.

At step S531, in the case of stopping, the elevator control apparatus 100 may notify expected boarding availability to the platform in advance, at the time of stopping or before stopping.

At step S550, if the elevator control apparatus 100 has determined not to stop the elevator 10, it may provide the non-stop notification to the platform.

If the elevator control apparatus 100 has determined not to stop the elevator 10 at the platform, the elevator control apparatus 100 may notify it to the robot on standby on the corresponding platform, and may notify non-stop decision to passengers on standby through the display included in the robot on standby.

If it stops the elevator 10 according to an internal call afterwards, the elevator control apparatus 100 may perform the step S510 of checking the elevator free space, and may repetitively perform the step S520 to the step S550.

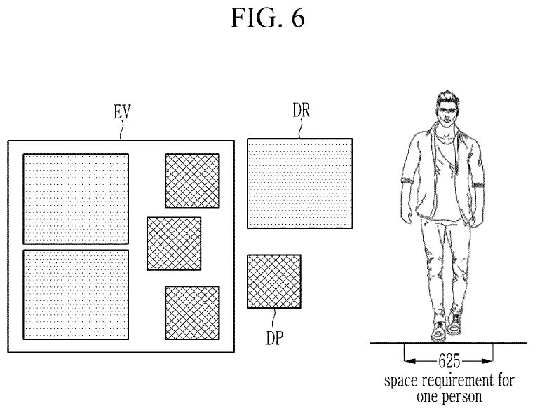

FIG. 6 is a drawing for explaining the free space detection method.

The elevator control apparatus 100 may calculate the free space within the elevator, and the number of passengers or robots that can be additionally boarded on the free space based on the interior area of the elevator, the number of boarded passengers or robots, and the predetermined occupancy area per passenger or the predetermined occupancy area per robot within the elevator.

The elevator control apparatus 100 may predict a required additional space within the elevator based on the area of the free space within the elevator, the number of passengers and robots on standby at the platform, and the predetermined occupancy area per passenger or the predetermined occupancy area per robot within the elevator.

In FIG. 6, the interior area of the elevator may be predetermined according to the type of the elevator. For example, the interior area of the elevator EV may be determined to the level enabling boarding of 15 passengers. At this time, the occupancy area per passenger may be predetermined.

For example, the occupancy area per passenger may be 65 cm×65 cm. The interior area of the elevator may be 2050 cm×2330 cm.

The occupancy area per robot may also be predetermined. For example, the occupancy area per robot may be 110 cm×110 cm.

If two robots and three passengers are boarded on the elevator, the elevator control apparatus 100 may determine that there is a free space within the elevator, and may calculate the free space. The elevator control apparatus 100 may calculate the number of passengers and the number of robots that can be boarded according to the calculated free space.

An elevator control apparatus may include a free space detector configured to detect the free space within the elevator based on CCTV within an elevator and data receive by a robot, a boarding demand prediction unit configured to predict a boarding demand of the platform based on platform monitoring data, and an elevator controller configured to determine whether to stop at the platform based on the boarding demand and the free space, where the elevator controller may be configured to predict the number of passengers and the number of robots that can be boarded and provide them to the corresponding platform when it has determined to stop, and to provide a non-stop notification to the corresponding platform when it has determined not to stop.

The free space detector may be configured to detect the free space in real time whenever the elevator stops and an elevator door is opened and closed.

The free space detector may be configured to calculate the free space and the number of passengers or the robots that can be additionally boarded on the free space based on an interior area of the elevator, the number of boarded passengers or the robots, and a predetermined occupancy area per passenger or robot within the elevator.

The free space detector may be configured to recognize a passenger or robot being boarded or getting-off through the robot within the elevator whenever the elevator stops, detect an expected get-off platform of the passenger or robot based on data with respect to the recognized the passenger or robot, and predict a free space to be secured at a next stopping platform based on the detected the expected get-off platform.

When a call button is input from the platform, the boarding demand prediction unit may be configured to receive the number of passengers and robots on standby at the platform provided from the robot existing at the platform as the boarding demand and to predict a required space within the elevator based on the receive boarding demand.

The boarding demand prediction unit may be configured to predict a required space within the elevator based on an area of the free space within the elevator, the number of passengers and robots on standby at the platform, and a predetermined occupancy area per passenger or robot within the elevator.

When an elevator call button is input from the platform, the elevator controller may be configured to determine whether the elevator stops at the platform.

The elevator controller may be configured to, when there is not the free space, determine not to stop at the platform, and when there is the free space, determine whether the free space and the boarding demand are matched, and determine to stop at the platform only when they are matched.

When one or more passengers or robots on standby at the platform may occupy the free space, the elevator controller may be configured to determine that the free space and the boarding demand are matched.

When it has determined not to stop at the platform, the elevator controller may be configured to notify it to the robot on standby on the corresponding platform, and to notify it to passengers on standby through a display means included in the robot on standby.

An elevator control method may include detecting the free space within the elevator based on CCTV within an elevator and data receive by a robot, predicting a boarding demand of the platform based on platform monitoring data, determining whether to stop at the platform based on the boarding demand and the free space, and predicting the number of passengers and the number of robots that can be boarded and provide them to the corresponding platform when it has determined to stop, and providing non-stop notification to the corresponding platform when it has determined not to stop.

The detecting the free space within the elevator may include detecting the free space in real time whenever the elevator stops and an elevator door is opened and closed.

The detecting the free space within the elevator may include calculating the free space and the number of passengers or the robots that can be additionally boarded on the free space based on an interior area of the elevator, the number of boarded passengers or the robots, and a predetermined occupancy area per passenger or robot within the elevator.

The detecting the free space within the elevator may include recognizing a passenger or robot being boarded or getting-off through the robot within the elevator whenever the elevator stops, detecting an expected get-off platform of the passenger or robot based on data with respect to the recognized passenger or robot, and predicting a free space to be secured at a next stopping platform based on the detected the expected get-off platform.

The predicting the boarding demand of the platform may include, when a call button is input from the platform, receiving the number of passengers and robots on standby at the platform provided from the robot existing at the platform as the boarding demand and predicting a required space within the elevator based on the receive boarding demand.

The predicting the boarding demand of the platform may include predicting a required space within the elevator based on an area of the free space within the elevator, the number of passengers and robots on standby at the platform, and a predetermined occupancy area per passenger or robot within the elevator.

The determining whether to stop at the platform may include, determining whether the elevator stops at the platform when an elevator call button is input from the platform.

The determining whether to stop at the platform may further include determining not to stop at the platform when there is not the free space, and determining whether the free space and the boarding demand are matched when there is the free space, and determining to stop at the platform only when they are matched.

The determining whether the free space and the boarding demand are matched may include determining that the free space and the boarding demand are matched when one or more passengers or robots on standby at the platform may occupy the free space.

The providing the non-stop notification may include, when it has determined not to stop at the platform, notifying it to the robot on standby on the corresponding platform, and notifying it to passengers on standby through a display means included in the robot on standby.

An elevator control apparatus and method according to an embodiment identifies a space available for boarding on the elevator in real time by using image information identified in real time by a CCTV of an elevator, a robot boarded on the elevator and/or a robot on standby in a hall of respective platforms, thereby reducing an unnecessary elevator stopping.

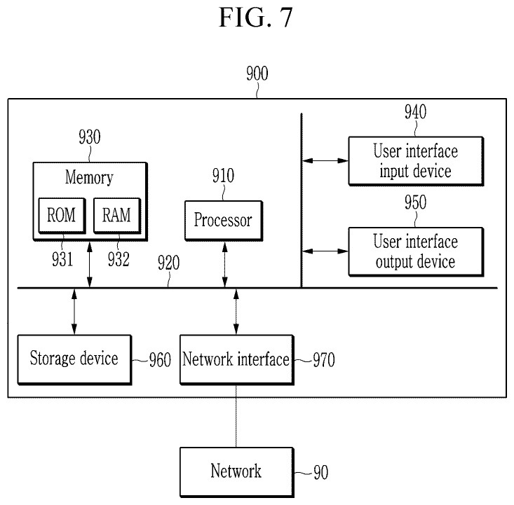

FIG. 7 shows an example computing device.

Referring to FIG. 7, the elevator control device and method described herein may be implemented using a computing device 900.

The computing device 900 may include at least one of a processor 910, a memory 930, the user interface input device 940, the user interface output device 950 and a storage device 960 that communicate through a bus 920. The computing device 900 may also include a network interface 970 electrically connected to a network 90. The network interface 970 may transmit or receive signals with other entities through the network 90.

The processor 910 may be implemented in various types such as a micro controller unit (MCU), an application processor (AP), a central processing unit (CPU), a graphic processing unit (GPU), a neural processing unit (NPU), and the like, and may be any type of semiconductor device capable of executing instructions stored in the memory 930 or the storage device 960. The processor 910 may be configured to implement the functions and methods described above with respect to FIG. 1 to FIG. 6.

The memory 930 and the storage device 960 may include various types of volatile or non-volatile storage media. For example, the memory may include read-only memory (ROM) 931 and a random-access memory (RAM) 932. In this configuration, the memory 930 may be located inside or outside processor 910, and the memory 930 may be connected to the processor 910 through various known means.

In some implementations, at least some components or functions of the elevator control device and method described herein may be implemented as programs or software executed by the computing device 900, and the programs or software may be stored in a computer-readable medium.

In some implementations, at least some components or functions of the elevator control device and method described herein may be implemented using hardware or circuitry of the computing device 900, or implemented using a separate device that may be electrically connected to the computing device 900.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. An elevator control apparatus, comprising:
a transceiver;
an elevator controller;
at least one processor; and
a memory storing instructions that, when executed by the at least one processor, are configured to cause the elevator control apparatus to:
receive, via the transceiver, an image generated using at least one sensor;
determine, based on the image and based on data received from a robot, a free space within a first elevator of at least one elevator, wherein the at least one sensor is configured to detect at least one occupant in the at least one elevator, and wherein the at least one occupant comprises at least one of a person or a robot;
determine, based on monitoring data associated with a platform, a boarding demand associated with the platform;
based on the boarding demand and the free space, determine whether to stop the first elevator at the platform; and
control the elevator controller to:
stop the first elevator at the platform, and transmit, to a device at the platform using the transceiver, a notification indicating information associated with the free space; or
operate the first elevator without stopping at the platform, and transmit, to the device at the platform using the transceiver, a non-stop notification,
wherein the device at the platform comprises at least one of the first elevator or a robot located at the platform.

2. The elevator control apparatus of claim 1, wherein the instructions, when executed by the at least one processor, are configured to cause the elevator control apparatus to determine the free space in real time when the first elevator stops and an elevator door of the first elevator is opened and after the elevator door of the first elevator is closed.

3. The elevator control apparatus of claim 1, wherein the instructions, when executed by the at least one processor, are configured to cause the elevator control apparatus to determine the free space and determine, based on an interior area of the first elevator, a number of passengers in the first elevator and a number of robots that can be accommodated in the free space, wherein the free space is determined based on a number of boarded passengers a number of boarded robots in the first elevator and based on a predetermined occupancy area per passenger and a predetermined occupancy area per robot within the first elevator.

4. The elevator control apparatus of claim 1, wherein the instructions, when executed by the at least one processor, are configured to cause the elevator control apparatus to:
recognize, via the robot within the first elevator, a passenger or robot being boarded or getting-off when the first elevator stops;
detect an expected get-off platform of the passenger or robot based on data associated with the recognized passenger or robot; and
predict, based on the detected the expected get-off platform, a free space to be secured at a next stopping platform.

5. The elevator control apparatus of claim 1, wherein the instructions, when executed by the at least one processor, are configured to:
based on a call button input from the platform, receive, from the robot located at the platform, a number of passengers and robots on standby at the platform as the boarding demand; and
predict, based on the boarding demand, a required space within the first elevator.

6. The elevator control apparatus of claim 1, wherein the instructions, when executed by the at least one processor, are configured to predict a required space within the first elevator based on:
an area of the free space within the first elevator,
a number of passengers and robots on standby at the platform,
a predetermined occupancy area per passenger within the first elevator, and
a predetermined occupancy area per robot within the first elevator.

7. The elevator control apparatus of claim 1, wherein the instructions, when executed by the at least one processor, are configured to:
based on an elevator call button input from the platform, determine whether to stop the first elevator at the platform.

8. The elevator control apparatus of claim 7, wherein the instructions, when executed by the at least one processor, are configured to:
based on the free space being smaller than a threshold space, determine not to stop the first elevator at the platform; and
based on the free space being larger than the threshold space and based on a determination that the free space and the boarding demand are matched, determine to stop the first elevator at the platform.

9. The elevator control apparatus of claim 8, wherein the instructions, when executed by the at least one processor, are configured to:
based on a determination that one or more passengers or robots on standby at the platform is able to occupy the free space, determine that the free space and the boarding demand are matched.

10. The elevator control apparatus of claim 1, wherein the instructions, when executed by the at least one processor, are configured to:
based on a determination to bypass the platform without stopping the first elevator, transmit, to the robot located at the platform, an indication that the first elevator does not stop at the platform, and display, via a display mounted on the robot located at the platform, a message indicating that the first elevator does not stop at the platform.

11. An elevator control method, comprising:
receiving, by an apparatus via a transceiver, an image generated using at least one sensor;
determining, based on the image and based on data received from a robot, a free space within a first elevator of at least one elevator, wherein the at least one sensor is configured to detect at least one occupant in the at least one elevator, and wherein the at least one occupant comprises at least one of a person or a robot;
determining, based on monitoring data associated with a platform, a boarding demand associated with the platform;
based on the boarding demand and the free space, determining whether to stop the first elevator at the platform; and
controlling an elevator controller to:
stop the first elevator at the platform, and transmit, to a device at the platform using the transceiver, a notification indicating information associated with the free space; or
operate the first elevator without stopping at the platform, and transmit, to the device at the platform using the transceiver, a non-stop notification.

12. The elevator control method of claim 11, wherein the determining the free space within the first elevator comprises determining the free space in real time when the first elevator stops and an elevator door of the first elevator is opened and after the elevator door of the first elevator is closed.

13. The elevator control method of claim 11, wherein the determining the free space within the first elevator comprises determining the free space and determining, based on an interior area of the first elevator, a number of passengers in the first elevator and a number of robots that can be accommodated in the free space, wherein the free space is determined based on a number of boarded passengers a number of boarded robots in the first elevator and based on a predetermined occupancy area per passenger and a predetermined occupancy area per robot within the first elevator.

14. The elevator control method of claim 11, wherein the determining the free space within the first elevator comprises:
recognizing, via the robot within the first elevator, a passenger or robot being boarded or getting-off when the first elevator stops;
detecting an expected get-off platform of the passenger or robot based on data associated with the recognized passenger or robot; and
predicting, based on the detected the expected get-off platform, a free space to be secured at a next stopping platform.

15. The elevator control method of claim 11, wherein the determining the boarding demand associated with the platform comprises:
based on a call button input from the platform, receiving, from the robot located at the platform, a number of passengers and robots on standby at the platform as the boarding demand; and
predicting, based on the boarding demand, a required space within the first elevator.

16. The elevator control method of claim 11, wherein the determining the boarding demand associated with the platform comprises predicting a required space within the first elevator based on:
an area of the free space within the first elevator,
a number of passengers and robots on standby at the platform,
a predetermined occupancy area per passenger within the first elevator, and
a predetermined occupancy area per robot within the first elevator.

17. The elevator control method of claim 11, wherein the determining whether to stop the first elevator at the platform comprises
based on an elevator call button input from the platform, determining whether to stop the first elevator at the platform.

18. The elevator control method of claim 17, wherein the determining whether to stop the first elevator at the platform comprises:
based on the free space being smaller than a threshold space, determining not to stop the first elevator at the platform; or
based on the free space being larger than the threshold space and based on a determination that the free space and the boarding demand are matched, determining to stop the first elevator at the platform.

19. The elevator control method of claim 18, wherein the determining whether the free space and the boarding demand are matched comprises:
based on a determination that one or more passengers or robots on standby at the platform is able to occupy the free space, determining that the free space and the boarding demand are matched.

20. The elevator control method of claim 11, further comprising:
based on a determination to bypass the platform without stopping the first elevator, transmitting, to the robot located at the platform, an indication that the first elevator does not stop at the platform and displaying, via a display mounted on the robot located at the platform, a message indicating that the first elevator does not stop at the platform.
